(19) United States
(12) Patent Application Publication
(10) Pub. No.: US 2005/0160589 A1
(43) Pub. Date: Jul. 28, 2005

(54) Sprocket tube inserter for heat exchanger manufacturing

(76) Inventors: Galen M. Bowen, Chico, CA (US); Richard O. Rhodes, San Francisco, CA (US); Frank Lucido, Vacaville, CA (US)

Correspondence Address: Audrey A. Millemann;Weintraub Genshlea Chediak Sproul, 11th Floor, 400 Capitol Mall, Sacramento, CA, 95814, US

(21) Appl. No.: 11/044,914

(22) Filed: Jan. 26, 2005

Related U.S. Application Data
(60) Provisional application No. 60/539,668, filed on Jan. 27, 2004.

(51) Int. Cl. B23P 15/26

(52) U.S. Cl. 29/726.5

(57) ABSTRACT

The invention is a tube inserter used in manufacturing heat exchangers, in particular, heat exchangers made of cut tubes. The tube inserter includes a frame, tubing feed channel, clip strip feed channel, and sprocket assembly. The sprocket assembly includes a sprocket, hub, and shaft. The clip strip feed channel receives clip strips and the tubing feed channel receives cut tubes. The sprocket inserts cut tubes into the clip strips and simultaneously advances the clip strips. The tube inserter may be used to produce heat exchanges of different widths and arrays of multiple heat exchangers. Multiple heat inserters may also be used in a heat exchanger production line.

### CROSS-REFERENCE TO RELATED APPLICATION

The present application claims the benefit of U.S. provisional patent application No. 60/539,668, filed Jan. 27, 2004 and entitled “Sprocket Tube Inserter for Heat Exchanger Manufacturing,” which is hereby incorporated by reference.

### BACKGROUND OF THE INVENTION

1. Field of the Invention

The present invention relates to the manufacture of heat exchangers, in particular, heat exchangers that utilize sections of cut tubing.

2. Description of the Related Art

There are a number of different types of heat exchangers. FIG. 1 shows one type of heat exchanger, typically made of plastic tubing. Heat exchanger 10 includes a plurality of tubes 12 connected to each other by clip strips 14 and attached at each end to header pipe 16. This type of heat exchanger may be used in many different applications, including solar heating systems.

There are several methods for manufacturing heat exchangers. One method, described in U.S. Pat. No. 6,487,768, uses a heat exchanger production line which includes multiple tube inserters. Each tube inserter of this system has an actuator assembly for snapping the tubes into the clip strips, an indexer for advancing the clip strips, and a cleat for preventing the indexed clip strip from moving backward in between indexing operations. Thus, the manufacture of each heat exchanger requires two steps: actuating (snapping the tube into the clip strip) and indexing (advancing the clip strip to the next slot location). The tube inserter of this system has certain disadvantages. First, the many actuators required are expensive, and have high maintenance costs due to wear and the difficulty of synchronizing operation. Second, the actuators must be carefully adjusted to accurately align each tube with the corresponding slot in the clip strip prior to snapping the tube in place, as misalignment can damage the tube or the clip strip.

### SUMMARY OF THE INVENTION

The invention is an improved tube inserter that is used in manufacturing heat exchangers, such as solar panels, consisting of multiple tubes. The invention may be used with the heat exchanger manufacturing system described in U.S. Pat. No. 6,487,768.

The invention includes a tubing feed channel, a clip strip feed channel, a sprocket assembly, and a frame. The tube inserter receives tubing cut into set lengths, then automatically and sequentially inserts the tubes into a series of clip strips using the sprocket assembly. The clip strips are then cut, forming heat exchangers of separated tubes having the desired length and width. Header pipes can be attached to the ends of the cut tubing, forming fluid manifolds, and the separated tubes can be bent into multiple-pass heat exchangers.

The clip strips are the primary structural component of a heat exchanger, in that they align and support the tubes containing the heat exchange fluid. The clip strips have slots that hold the tubes in place once they have been snapped to the clip strip. Precise alignment of the tubes with the clip strip slot during insertion is necessary to prevent damaging the tube or the clip strip slot. Additionally, adequate insertion force is required to insert the tubes. The tube inserter of the invention meets these requirements.

The tube inserter of the invention improves production equipment reliability, increases production rate, and lowers product cost. The sprocket assembly performs the functions of the actuator and indexer of the tube inserter of U.S. Pat. No. 6,487,768. The sprocket assembly turns slowly, in contrast to an actuator and indexer, which move cyclically and up to several inches each cycle. Thus, the sprocket assembly more smoothly inserts tubes into the clip strips using greater force while simultaneously advancing them. The sprocket assembly also more accurately locates the tubes with the slots in the clip strips, and then inserts them without damaging the clip strip or the tube. The continuous motion possible with the sprocket assembly causes less wear than does cyclical motion, and allows a single motor to drive all the sprockets instead of multiple actuators, saving cost.

### BRIEF DESCRIPTION OF THE DRAWINGS

FIG. 1 is a perspective view of an example of a heat exchanger.

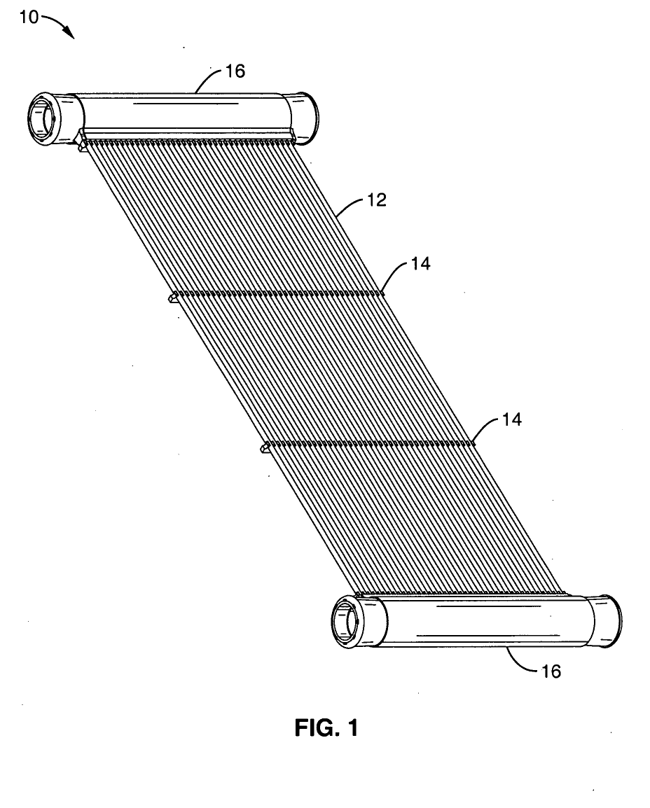

FIG. 2 is a first perspective view of the right side of the tube inserter of the invention, from the back.

FIG. 3 is a second perspective view of the right side of the tube inserter of the invention, from the front.

FIG. 4 is a perspective view of a single-sided type of clip strip.

### DETAILED DESCRIPTION OF THE INVENTION

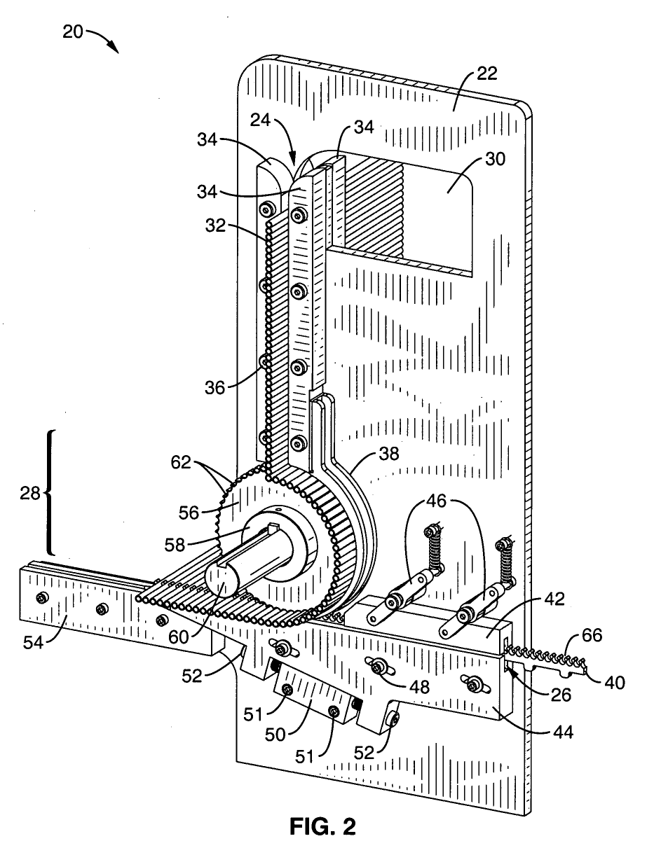

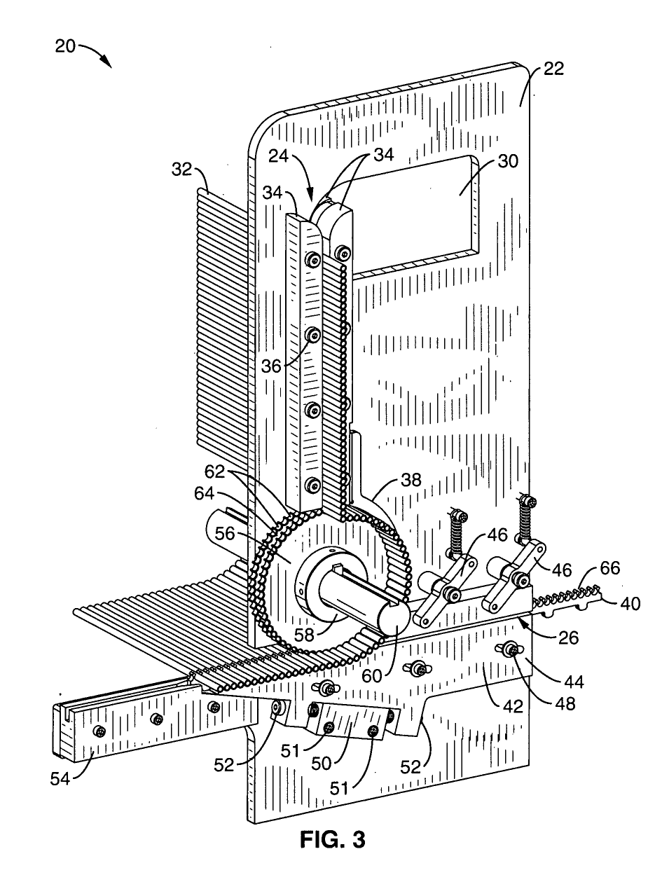

FIGS. 2 and 3 are perspective views of one embodiment of tube inserter 20 of the invention, from the right side, from different angles. Tube inserter 20 includes frame 22, tubing feed channel 24, clip strip feed channel 26, and sprocket assembly 28. Tubes 32 are preferably made of plastic, which may be extruded or formed by other methods. Tubes 32 may also be made of other materials, including metals and metal alloys.

Frame 22 may be rigidly or slidably mounted on a support beam. Frame 22 includes an opening that has two portions: conveyor slot 30 and a vertically oriented portion (not visible). Conveyor slot 30 is sized and shaped to receive a belt conveyor (not shown), which carries tubes 32 to be assembled to produce a heat exchanger. The height of conveyor slot 30 is sized to align the top surface of the conveyor with the top of tubing feed channel brackets 34, permitting each tube 32 delivered by the conveyor to be transported to tubing feed channel 24 by air knives or other means. The vertically oriented portion of the opening in frame 22 is aligned with tubing feed channel 24 to allow tubes 32 to fit between tubing feed channel brackets 34, and, at its lower end, curves to accommodate sprocket assembly 28.

Tubing feed channel 24 is a vertically oriented opening, sized to accommodate tubes 32 to be used. Tubing feed channel 24 is formed by tubing feed channel brackets 34, two of which are located on either side of frame 22. Each tubing feed channel bracket 34 is preferably mounted to frame 22 with tubing feed channel bolts 36. Tubing support guide 38 has a vertical portion connected to the rear tubing feed channel bracket 34 on one side of frame 22 (shown here on the right side), and a curved portion that extends around sprocket 56, with space for tubes 32 in between, and rests on each side of clip strip 40.

Clip strip feed channel 26 is a horizontally oriented opening sized to accommodate clip strip 40. Clip strip feed channel 26 is formed by clip strip feed channel clamp 42 and clip strip feed channel base 44, which are attached to the same side of frame 22 as is tubing support guide 38 (shown here on the right side). Clip strip feed channel clamp 42 can be adjusted in height to accommodate clip strips having different height dimensions, and is attached to frame 22 by spring-loaded arms 46. Spring loaded arms 46 cause clip strip feed channel clamp 42 to move downward, pressing clip strip 40 into clip strip feed channel base 44. Clip strip feed channel base 44 is attached to frame 22 by clip strip feed channel bolts 48. Adjustment block 50 is fixed to frame 22 with bolts 51. Adjustment bolts 52 are threaded through clip strip, feed channel base 44 and press against adjustment block 50. Clip strip feed channel bolts 48 can be loosened, and adjustment bolts 52 can be used to raise or lower clip strip feed channel base 44.

Base plate 54 is attached to clip strip feed channel base 44.

Sprocket assembly 28 preferably includes sprocket 56, hub 58, shaft 60, and a bearing (not shown). Sprocket 56 is a circular plate having a circular opening through which shaft 60 passes perpendicularly to sprocket 56. Sprocket 56 is preferably attached to shaft 60 with hub 58, although it may also be attached directly to shaft 60. Shaft 60 is connected to frame 22 by the bearing, or alternatively, a bushing. Shaft 60 is driven by a motor (not shown). Sprocket 56 has indentations 62 located uniformly around its rim that are sized and shaped to hold a tube 32. Indentations 62 are preferably semicircular, but other shapes may also work. If indentations 62 are semicircular, then the diameter of an indentation 62 is preferably about the same or slightly larger than the outer diameter of a tube 32. The sprocket circumferential distance between the center of each indentation 62 corresponds to the distance between the centers of adjacent tubes 32 in the assembled heat exchanger. As shown in FIG. 3, sprocket 56 also has groove 64 located in its rim.

In use, tube inserter 20 receives tubes 32 and clip strips 40, and inserts tubes 32 into clip strips 40, forming a heat exchanger. Each cut tube 32 is sequentially ejected from a tube conveyor (not shown), by air flow from an air knife (not shown) mounted to frame 22, or ejected by other means, into tubing feed channel 24, forming a stack of tubes 32. Tubing feed channel 24 receives each tube 32 and guides each tube 32 down to the top of sprocket assembly 28, and into the next indentation 62 in sprocket 56. The curved portion of tubing feed channel 24 holds tubes 32 in place in indentations 62. Sprocket 56 rotates continuously in a clockwise direction, spacing tubes 32 and moving each tube 32 down into position above clip strip 40 and into alignment with the next clip strip slot 66 in clip strip 40. Sprocket 56 then inserts each tube 32 into the corresponding clip strip slot 66, while simultaneously moving clip strip 40 and the previously inserted tubes 32 forward. Sprocket 56 automatically locates tube 32 and clip strip 40 precisely before insertion, and applies sufficient force to insert tube 32 into clip strip slot 66 without damaging tube 32 or clip strip 40. Sprocket 56 also advances clip strip 40, because the recently inserted tubes 32 remain in contact with both indentations 62 in the bottom of sprocket 56 and clip strip slots 66 in clip strip 40. Groove 64 in sprocket 56 prevents interference with clip strip 40 that passes under sprocket 56. Interference could result from the projections or teeth on clip strips 40 which contain tubes 32 and extend above the top surface of tubes 32. Clip strip feed channel 26 receives clip strip 40. Clip strip feed channel base 44 and clip strip feed channel clamp 42 both support and guide clip strip 40 directly under sprocket 56. Clip strip feed channel base 44 can be adjusted in height relative to sprocket 56 for inserting tubes 32 into clip strip 40. Clip strip 40 can be cut manually or automatically after it leaves sprocket 56 to form a heat exchanger having the desired width.

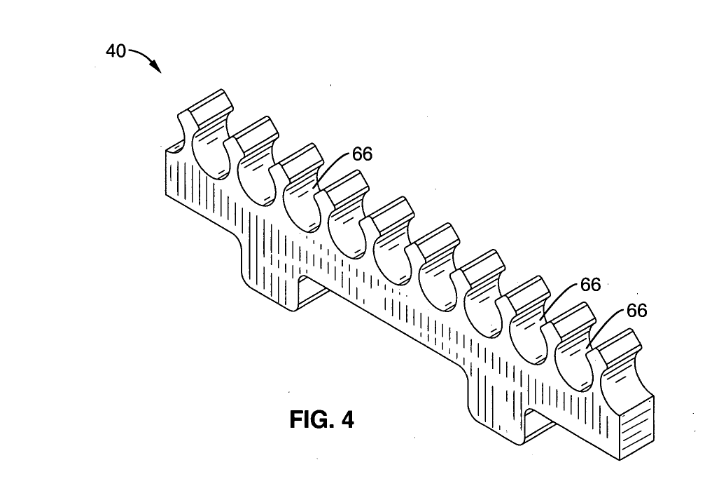

FIG. 4 shows an example of clip strip 40 that may be used with tube inserter 20. Clip strip 40 is a single-sided clip strip and has clip strip slots 66 along one side formed by projections or teeth. Clip strip slots 66 are sized to allow tubes 32 to fit snugly once they are inserted into clip strip 40. Tube inserter 20 will also work with other configurations of clip strips, such as dual-sided clip strips having clip strip slots on both sides. This would allow multiple heat exchangers to be clipped together to form an array of heat exchangers.

Tube inserter 20 can utilize sprockets 56 having different machined rim dimensions, which will produce heat exchangers having different tube diameters or tube spacing. For example, sprocket indentations 62 could be spaced to insert tubes 32 in alternate clip strip slots 66, or could be sized to receive tubing having a different diameter, e.g. ¼ or ⅛ inch. Additional components can be added to the tube inserter, for example, to cut shortened lengths of dual-sided clip strips that can be combined to form heat exchangers having multiple rows of tubes or that can be attached to form an array of heat exchangers.

Tube inserter 20 of the invention may also be used in a heat exchanger production line as described in commonly assigned U.S. Pat. No. 6,487,768, which is incorporated herein by reference. Multiple tube inserters 20 are aligned in series to produce heat exchangers of different lengths, as desired, and clip strips 40 are cut at the desired heat exchanger width. In such a production line, sprocket 56 in each tube inserter 20 is driven by a motor connected to shaft 60 that runs through each sprocket 56. Shaft 60 may be either a single, unitary shaft or multiple, interconnected shafts. Shaft 60 then aligns and rotates each sprocket 56 to assemble tubes 32 into clip strips 40 and simultaneously advance the heat exchanger.

The invention has been described above with reference to the preferred embodiments. Those skilled in the art may envision other embodiments and variations of the invention that fall within the scope of the claims.

1. A tube inserter, comprising:
a) a clip strip feed channel for receiving a clip strip;
b) a tubing feed channel for receiving tubing; and
c) a sprocket assembly for advancing said received clip strip through said clip strip feed channel and for pressing said received tubing into said clip strip.

2. The tube inserter of claim 1, wherein said received clip strip has slots along one side, sized to receive said tubing.

3. The tube inserter of claim 1, wherein said tubing is made of plastic.

4. The tube inserter of claim 1, wherein said sprocket assembly includes a sprocket and a shaft.

5. The tube inserter of claim 4, wherein said sprocket includes indentations uniformally spaced around the rim of said sprocket.

6. The tube inserter of claim 5, wherein said indentations are semicircular and further, wherein the diameter of said indentations is about the same as the outer diameter of said tubing.

7. The tube inserter of claim 1, further comprising a frame.
